(19) United States
(12) Patent Application Publication
(10) Pub. No.: US 2005/0150371 A1
(43) Pub. Date: Jul. 14, 2005

(54) System and method for the defense of aircraft against missile attack

(76) Inventor: John Terrell Rickard, Durango, CO (US)

Correspondence Address: DLA PIPER RUDNICK GRAY CARY US, LLP, 4365 EXECUTIVE DRIVE, SUITE 1100, SAN DIEGO, CA, 92121-2133, US

(21) Appl. No.: 10/766,097

(22) Filed: Jan. 27, 2004

Related U.S. Application Data
(60) Provisional application No. 60/443,765, filed on Jan. 29, 2003.

(51) Int. Cl. B64D 1/04

(52) U.S. Cl. 89/1.11

(57) ABSTRACT

A CM system for the defense of aircraft against missile attack leverages nanocrystal technology to provide safe and reliable protection. The CM system generally includes one or more ground-based laser emitter subsystems, one or more ground-based Doppler-sensitive radar subsystems, an aircraft-based nanocrystal dispenser subsystem, and an engagement control subsystem that governs the operation of the CM system. In response to the detection of a missile within an attack envelope, the engagement control subsystem instructs the dispenser subsystem to release nanocrystals into an area proximate the aircraft. In addition, the engagement control subsystem instructs one or more of the laser emitter subsystems to direct an excitation signal at the dispensed nanocrystal “cloud” to thereby cause the nanocrystals to emit infrared radiation that approximates that of jet engine exhaust. The properties of the nanocrystals and the excitation signal are selected to ensure that the emitted radiation provides an effective decoy for the missile seeker system.

### CROSS REFERENCE TO RELATED APPLICATION

This application claims the benefit of U.S. provisional application Ser. No. 60/443,765, the entire content of which is hereby incorporated by reference.

### FIELD OF THE INVENTION

The present invention relates generally to aircraft defense systems. More particularly, the present invention relates to a countermeasure (“CM”) system for the defense of aircraft against missile attack.

### BACKGROUND OF THE INVENTION

With the recent attempt by terrorists to down a commercial airliner using a shoulder fired surface-to-air missile (“SF-SAM”), one of the worst fears regarding future terrorism tactics has been confirmed. Estimates of the number of such missile systems (including the Russian built SA-7, SA-18 and the more sophisticated United States built Stinger) available on the black market number in the thousands. The small size of these systems makes them easy to smuggle and to conceal up to the point of actual launch of the missile.

The prospect of such an attack on a large commercial airliner (or worse yet, of multiple simultaneously coordinated attacks) is sobering to say the least. In addition to the large-scale loss of life resulting from successful attacks, the economic consequences would be Draconian in the extreme. A nation's entire air transportation system likely would be grounded, not so much due to government dictate as by the refusal of insurance carriers to provide liability policies to the airlines and by the widespread fear of flying that would be precipitated among the public. This could destroy an already battered airline industry, disrupt many business sectors dependent upon air transportation, and could plunge the country (and likely the world) into a deep recession. The economic costs could easily reach the hundreds of billions, perhaps even trillions, of dollars, and the loss of tax revenues to the government would be in the tens of billions at a minimum.

Given these consequences, it is imperative that CMs to this threat be developed. However, the CMs normally employed against such threats by military aircraft (i.e., threat warning sensors, flares, towed decoys, and high-g evasive maneuvers) are expensive, dangerous, and generally infeasible for use with commercial airliners. The regions of vulnerability of the latter to SF-SAM attack are predominately over populous urbanized areas in the approach and departure corridors of commercial airports, where the potential calamities resulting from burning flares dropping to the ground upon a false alarm would be unacceptable. Furthermore, commercial airliners are not built to withstand high-g evasive maneuvers, and even if they were, such maneuvers would carry an obvious high risk of injury and/or death among passengers. Thus a different approach to SF-SAM CMs is required to defend against this clear and present danger.

### BRIEF SUMMARY OF THE INVENTION

The system and techniques described herein deal with the threat to aircraft caused by man-portable air defense systems (“MANPADS”). The system eliminates the undesirable and/or infeasible aspects of current CMs, and can be constructed and deployed using a number of existing technologies. The example practical system described herein employs an aircraft mounted subsystem that dispenses a cloud of fluorescing nanocrystals in response to the receipt of a warning signal. The ground subsystem includes a network of inexpensive detectors/sensors that detect a missile launch within an approach/departure corridor. The ground subsystem also includes a transmitter for sending warning signals to aircraft in the vicinity, and a control system that activates a network of ground-based exciters (e.g., lasers) that cause the nanocrystal cloud to fluoresce in the infrared spectral band to create a decoy hot spot.

The above and other aspects of the present invention may be carried out in one form by a CM system for the defense of aircraft against missile attack. The system includes a dispenser, mounted on an aircraft, that dispenses a substance into an area within an attack envelope of the aircraft. The substance emits radiation in a first wavelength band when excited by incident radiation in a second wavelength band. The system also includes at least one exciter configured to generate illuminating radiation in the second wavelength band, and to direct the illuminating radiation toward the area that contains the substance. In accordance with one practical embodiment, the substance comprises nanocrystals.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic diagram of a CM system according to the present invention;

FIG. 2 is a schematic diagram of an aircraft within its attack envelope;

FIG. 3 is a schematic diagram of the ground-based components of the CM system shown in FIG. 1;

FIG. 4 is a schematic representation of a dispenser suitable for use with the CM system shown in FIG. 1;

FIG. 5 is a schematic representation of an exciter suitable for use with the CM system shown in FIG. 1;

FIG. 6 is a schematic representation of an engagement control subsystem suitable for use with the CM system shown in FIG. 1;

FIG. 7 is a graph of the absorption and emission spectra of a sample of nanocrystals;

FIG. 8 is a graph of the emission spectra for different sized nanocrystals;

FIG. 9 is a graph of the absorption spectrum for different sized nanocrystals;

FIG. 10 is a graph of emission spectra for different semiconductor materials formed into different sized nanocrystals, each displaying a different engineered bandgap;

FIG. 11 is a graph of absorption spectra of a series of different sized CdSe nanocrystals;

FIG. 12 is a graph depicting mass of nanocrystals versus cloud length for a CM application; and

FIG. 13 is a flow chart of an example CM process that may be carried out by the CM system shown in FIG. 1.

### DETAILED DESCRIPTION OF A PREFERRED EMBODIMENT

The present invention may be described herein in terms of functional block components and various processing steps. It should be appreciated that such functional blocks may be realized by any number of hardware, software, and/or firmware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols, sensor data fusion techniques, and radar and laser technologies, and that the system described herein is merely one exemplary application for the invention.

It should be appreciated that the particular implementations shown and described herein are illustrative of the invention and its best mode and are not intended to otherwise limit the scope of the invention in any way. Indeed, for the sake of brevity, conventional aspects of the systems (and the individual operating components of the systems) may not be described in detail herein.

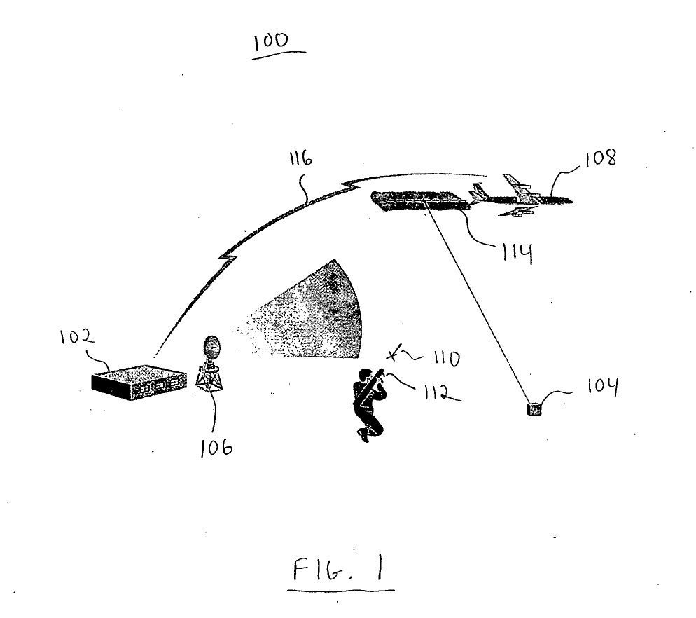

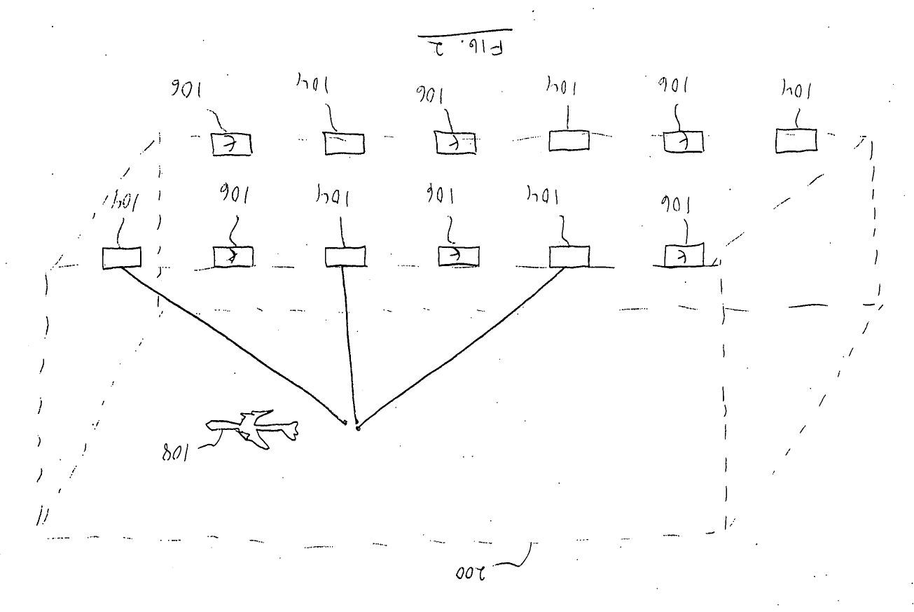

FIG. 1 is a schematic diagram of a CM system 100 that is suitable for use in the defense of aircraft against missile attack. Although the invention can be utilized as a CM against a variety of missile types, the example embodiment described herein is suitably configured to address the threat posed by man-portable air defense systems (“MANPADS”) such as shoulder fired surface-to-air missiles (“SF-SAMs”). CM system 100 generally includes an engagement control subsystem 102, at least one exciter 104, at least one detector 106, and a dispenser (not shown) mounted on an aircraft 108. For illustrative purposes, FIG. 1 also depicts a missile 110 deployed from a SF-SAM 112, and a “cloud” containing a CM substance (e.g., nanocrystals) 114 dispensed from aircraft 108. Engagement control subsystem 102 communicates with exciter 104, detector 106, and the aircraft-mounted dispenser. In most practical embodiments, engagement control subsystem 102, exciter 104, and detector 106 are ground-based components (alternatively, detector 106 may be aircraft-mounted). Furthermore, CM system 100 may employ a plurality of exciters 104 and a plurality of detectors 106, as depicted in FIG. 2.

CM system 100 is a hybrid aircraft and ground-based system that places the more costly and high-maintenance components on the ground so as to scale as the number of airports rather than as the number of aircraft. In practical embodiments, the aircraft-mounted dispenser is lightweight, relatively inexpensive, very low maintenance, and can be installed in such a manner as to produce a virtually zero increase in aerodynamic drag. In addition to these major advantages, CM system 100 is able to defeat multiple missile launches and sophisticated multi-band and kinematic tracking missile seekers. Thus, it overcomes many of the serious deficiencies of current CM approaches as applied to the commercial aviation arena.

The general threat addressed by CM system 100 is from all classes of MANPADS produced by the world's arms suppliers. However, given that the Russian-made SA-7 (a and b models) has by far the greatest proliferation on the black market, the example embodiment described herein focuses on this threat. The SA-7b model of this missile has a slant range of about 4.2 km, a maximum altitude of about 2300 m, and a speed of about 500 m/sec. These missiles are generally tail-chase systems, which are launched from, and home from, the rear hemisphere of the aircraft. Nonetheless, these missiles must be countered from any quarter.

The passive seeker in the SA-7 is designed to detect and home on infrared (“IR”) emissions within certain regions of the 2.5-4.4 micron wavelength band, where jet engine exhaust radiance typically peaks. The homing guidance and control system is dependent upon observing a hot spot within this band that stands out clearly against a much lower intensity background. Once this spot is within the field of view (“FOV”) of the missile sensor, the missile guidance system adjusts the aim point of the missile to keep this spot centered in the sensor FOV, using proportional convergence logic. A contact fuse (flush or grazing) initiates warhead detonation, and the pressure wave and splinters resulting from the explosion destroy the target.

More advanced threats include the SA-18, which has a slant range of 5.2 km and a maximum altitude of 3500 m. This missile also employs a dual-band seeker, with the second band in the ultraviolet (“UV”) region, to discriminate decoy flares (which emit significant UV radiation) from engine exhaust. Since the example embodiment described herein does not generate emissions in the UV region, it is immune to this counter-CM.

CM system 100 employs an application of nanotechnology to create a “hot spot” that is spectrally similar to, but more intense than, jet exhaust emissions. The “hot spot” tracks along at a distance of several tens of meters behind the aircraft. This will decoy the missile seeker away from the jet exhaust, causing the missile to pass harmlessly behind the aircraft. CM system 100 can naturally handle the problem of multiple missiles launched at the aircraft, since each missile will be decoyed by the same hot spot. Since CM system 100 does not generate emissions in the UV region, or in any spectral region other than the desired band, it is immune to multi-band seeker discrimination against false targets.

The regions of vulnerability of commercial aircraft are along the approach and departure corridors around commercial airports. Given the performance characteristics of the threat and the approach and departure profiles of commercial aircraft, these corridors would be roughly 25 km in length and 7 to 10 km wide. Within this area, and at heights ranging from near ground level up to 2300 m (for the SA-7b) or 3500 m (for the SA-18), an airliner is potentially vulnerable. However, airliners will be making their approach/departure along fairly static, predictable routes through these corridors. Consequently, the ground portions of CM system 100 can be concentrated along these routes. The vulnerable corridors are also referred to herein as “attack envelopes.” FIG. 2 schematically depicts such an attack envelope 200, along with several ground-based components of CM system 100.

The total engagement time for a SF-SAM is on the order of seconds. Thus, any effective CM must have an extremely rapid response time. This implies a “point defense” type of CM system for the aircraft, as opposed to a system involving intercept of the SAM (the latter might be feasible using precision-focused directed energy weapons, but this would create additional dangers for the aircraft). Indeed, current CM systems employ either decoy flares or towed decoys, or aircraft mounted lasers or high intensity lamps. The latter are designed to track the bearing of the incoming missile and optically saturate the missile sensor using highly collimated and/or high intensity IR radiation, thus blinding it.

However, all of these approaches have serious disadvantages for commercial aircraft fleets. Downward-looking IR sensing to alert to an incoming missile over populous urban/industrial areas would likely generate unacceptable false alarm rates due to thermal sources at ground level, and flare deployment over such areas could have calamitous results. The same is true of towed decoys, which risk snapped tow cables and must be jettisoned before landing, and are therefore expensive and hazardous to people/structures on the ground.

Aircraft mounted laser and/or lamp systems also are expensive both to procure and to maintain (estimates in the popular press range from one to two million dollars acquisition cost per aircraft, which would require a many-billion dollar capital investment for a large commercial aircraft fleet, with very high ongoing maintenance costs), and they add significant drag to the aerodynamics of the aircraft.

These considerations argue for a CM system that, while retaining the characteristics of a point defense system, minimizes the cost and complexity of the aircraft-mounted component of the system. The system described herein addresses the shortcomings of conventional approaches.

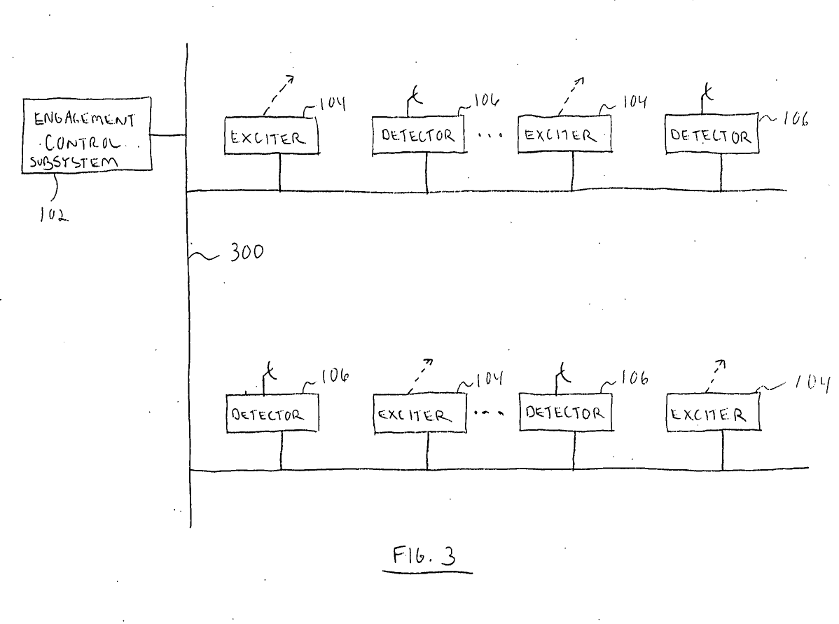

Referring again to FIG. 1 and FIG. 2, a practical implementation of CM system 100 includes a plurality of exciters 104 and a plurality of detectors 106 located in strategic positions in and/or around attack envelope 200. FIG. 3 is a schematic diagram of the ground-based components of CM system 100, again showing a plurality of exciters 104 and a plurality of detectors 106. The number of exciters 104, the number of detectors 106, the relative positioning of the components, and the overall layout of CM system 100 may vary from that shown in the figures, and the particular configuration of a practical CM system 100 can be customized according to the specific threats, airport layouts, environmental conditions, and other factors. FIG. 3 depicts a data communication bus 300 connecting engagement control subsystem 102 to the exciters 104 and the detectors 106. In practice, data communication bus 300 may employ conventional landline and/or wireless communication channels between the components. Data communication bus 300 facilitates control and monitoring of detectors 106 and exciters 104 by engagement control subsystem 102, and facilitates the transmission of sensor data, control signals, and other data to and from engagement control subsystem 102.

The practical embodiment of CM system 100 generally comprises three major subsystems: a sensor/detector suite; an aircraft-mounted nanocrystal dispenser; and a suite of ground-based laser exciters. In the practical embodiment, these subsystems are controlled by engagement control subsystem 102.

The sensor/detector suite preferably comprises a ground-based network of small dual-mode continuous-wave (“CW”) Doppler and pulse-Doppler radars (or any Doppler-sensitive radar), potentially augmented with upward-looking IR/visual imaging sensor elements configured to detect missile plumes or other events indicative of the presence of a missile within attack envelope 200. Alternatively (or additionally), CM system 100 can employ any number of aircraft-mounted detectors such as IR imaging sensors and/or visual imaging sensors. The detectors are preferably networked via data communication bus 300 to provide event data to engagement control subsystem 102. In the example embodiment described herein, detectors 106 form this sensor suite. In practical embodiments, engagement control subsystem 102 is located in proximity to the airport and, preferably, within the secured perimeter of the airport. Engagement control subsystem 102 comprises one or more suitably configured processors that analyze the event data to determine whether a missile is present within attack envelope 200. In this regard, engagement control subsystem 102 may utilize any number of data fusion, artificial intelligence, and/or attack simulation techniques. This sensor system will immediately detect the launch and flight of a SF-SAM anywhere within attack envelope 200 of the CM system, with very low probability of false alarms. The false alarm probability is very low because there will be no target in attack envelope 200 with anywhere near the Doppler effect associated with a missile.

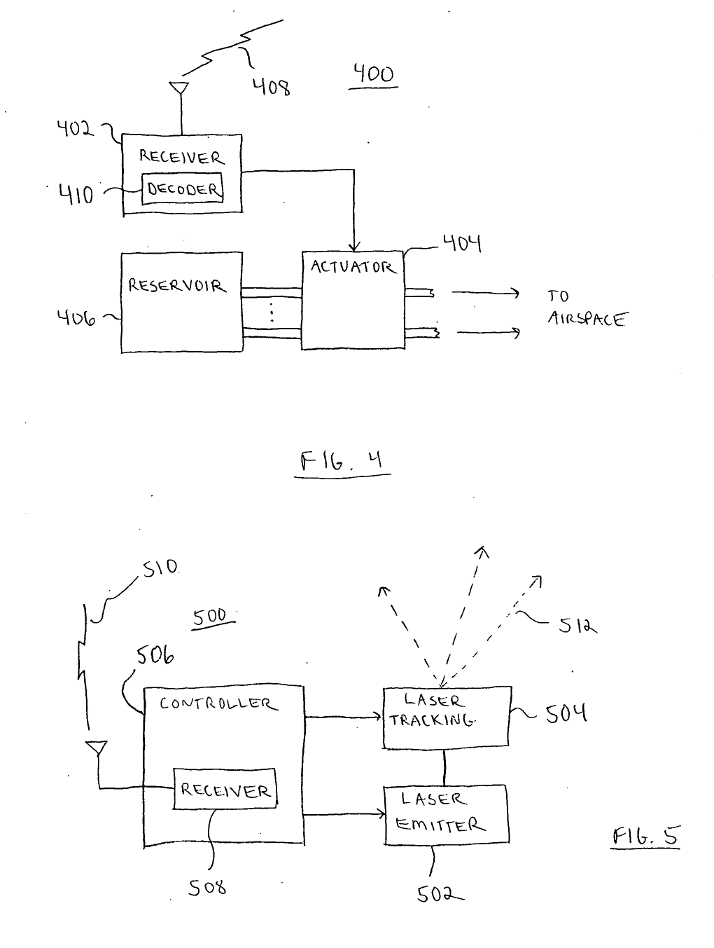

The dispenser can be a back fitted, aerodynamic pod (or pods) mounted on the fuselage, wing, or engine pylon of each aircraft. Alternatively, the dispenser can be internal to the aircraft, with small tubes running through the wings or fuselage to flush-mounted nozzles in one or more engine pylons or bypass nacelles, which would virtually eliminate any aerodynamic drag associated with the system. FIG. 4 is a schematic representation of a dispenser subsystem 400 suitable for use in connection with CM system 100. Dispenser subsystem 400 preferably includes (or communicates with) a receiver 402, an actuator 404, and a reservoir 406 that contains nanocrystals, a nanocrystal solution, suspension, or mixture, or other suitable substance. In the example embodiment, dispenser subsystem 400 is configured to release an aerosol trail of nanocrystals in response to the receipt of a coded engagement signal 408 transmitted from engagement control subsystem 102.

Receiver 402 includes or communicates with a decoder 410, which operates to decode engagement signal 408 in accordance with the particular coding scheme. The coding of engagement signal 408 reduces the likelihood of false alarms and/or intentional spoofing. In accordance with one practical embodiment, dispenser subassembly 400 is a self-contained component and receiver 402 is integrated with dispenser subassembly 400. Self-contained dispenser assemblies are easy to deploy and install in an existing fleet of aircraft.

Receiver 402 communicates with actuator 404 and, upon receipt and decoding of engagement signal 408, causes actuator 404 to release the contents of reservoir 406 into the airspace proximate the aircraft. In practice, dispenser 400 can include any number of conduits from reservoir 406. As schematically depicted in FIG. 1, dispenser 400 releases the substance into an area or region 114 within the attack envelope of the aircraft. In the preferred embodiment, dispenser 400 releases the substance behind the aircraft.

The exciters 104 are preferably realized as a plurality of ground-based laser emitters. These laser emitters operate in the near-infrared regime to penetrate clouds, fog, and the like. The exciters track behind the aircraft within the attack envelope (preferably, on approach/departure), activate upon warning of a missile within the attack envelope, and generate a suitable excitation signal to illuminate the aerosol region behind the threatened aircraft(s). The excitation signal causes the airborne aerosol substance to fluoresce, thus creating a highly realistic false target and/or high background energy in the wavelength bands of the attack missile seeker systems.

FIG. 5 is a schematic representation of an exciter 500 suitable for use with the CM system shown in FIG. 1. In the practical implementation, exciter 500 includes at least one laser emitter 502, a laser tracking element 504, and a controller 506. Controller 506 includes or communicates with a receiver 508 configured to receive an engagement signal 510 that is indicative of the presence of a missile within attack envelope 200. Notably, engagement signal 510 may be transmitted via a wireless data communication channel or a landline data communication channel. In practice, engagement signal 510 is generated by engagement control subsystem 102. As described above in connection with dispenser subsystem 400, engagement signal 510 may be encoded for purposes of security and to reduce false alarms. Receiver 508 communicates with laser emitter 502 and, upon receipt of engagement signal 510, laser emitter 502 generates a suitable excitation signal 512 (e.g., a laser beam). In addition, laser tracking element 504 is controlled to direct excitation signal 512 at an area, proximate the aircraft, that contains the released substance. In this example, excitation signal 512 is directed toward the region 114 that contains the dispensed nanocrystals. As described in more detail below, excitation signal 512 has certain properties that cause the dispensed substance to emit radiation having characteristics that approximate the characteristics of the engine exhaust of the aircraft.

As briefly mentioned above, exciter 500 may be controlled to track aircraft upon departure and arrival, even when no threat exists. As schematically depicted in FIG. 2 and FIG. 5, one or more exciters can track an aircraft such that, if a missile is detected, the excitation signal can be immediately generated and emitted with little or no latency caused by searching or location tracking. The actual tracking control may be carried out by engagement control subsystem 102 and/or by exciter 500 itself.

The dual-mode radars in the system can routinely track airliners within the approach/departure corridors of vulnerability, and watch for the sudden appearance of a very high-Doppler, small cross-section target(s). High angular resolution of these radars is not required, since there can be multiple radars observing a narrow corridor, yielding simultaneous range/Doppler measurements on the large targets represented by airliners, which are flying essentially straight line or known maneuver trajectories. This provides a high degree of state vector (i.e., position and velocity) observability on the airliners in the corridor. The engagement control subsystem can process and analyze this information with tracks from existing airport radars, yielding very precise state estimates on the airliners.

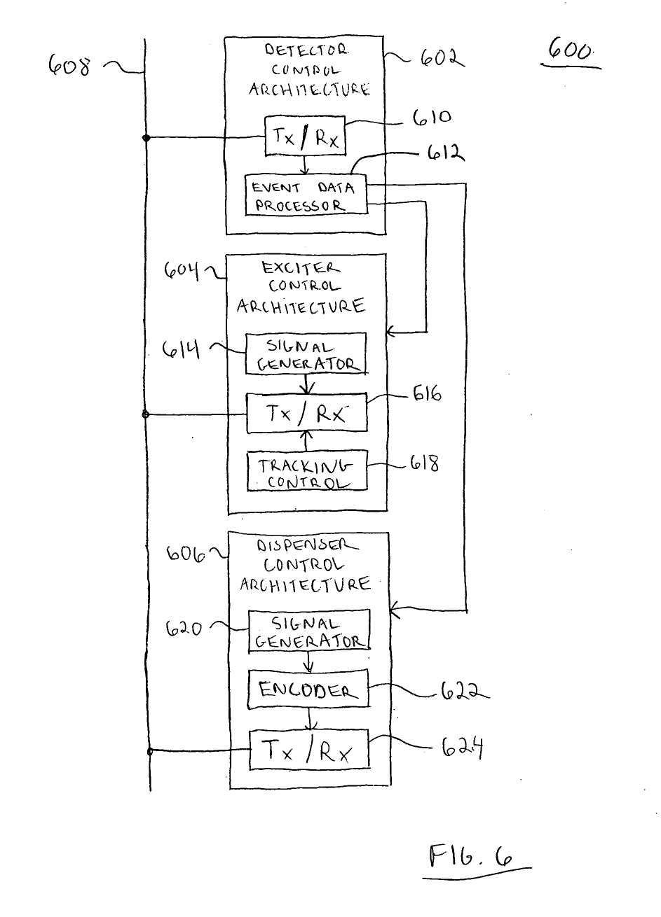

FIG. 6 is a schematic representation of an engagement control subsystem 600 suitable for use with CM system 100. Engagement control subsystem 600 is preferably located within the secure perimeter of the airport, e.g., within the airport control tower. Indeed, engagement control subsystem 600 may leverage existing components within the airport control tower. Conventional aspects of a practical subsystem, such as data communication technologies, computer hardware elements, microprocessor details, and the like, are not addressed herein.

Engagement control subsystem 600 may include a suitably configured control architecture that controls CM system 100. For ease of description, FIG. 6 depicts distinct “blocks” corresponding to a detector control architecture 602, an exciter control architecture 604, and a dispenser control architecture 606. Engagement control subsystem 600 may include or otherwise communicate with a data communication bus 608. In this schematic representation, bus 608 facilitates communication between the various elements of engagement control subsystem 600 and other components of CM system 100.

Detector control architecture 602 includes a communication element 610 that comprises a receiver (and possibly a transmitter) for communicating with detectors 106. Communication element 610 is configured to receive, from at least one detector 106, sensor/event data indicative of the presence of a missile within attack envelope 200 of an aircraft. Detector control architecture 602 also includes a processor 612 configured to analyze the sensor/event data to determine whether a missile is present within attack envelope 200. As mentioned above, processor 612 may employ data fusion methodologies to determine the likelihood of a missile attack. Processor 612 communicates with exciter control architecture 604 and with dispenser control architecture 606 as necessary when a missile attack is detected.

Exciter control architecture 604 includes an engagement signal generator 614 that generates an engagement signal for controlling at least one exciter 104. In the example embodiment, signal generator 614 generates the engagement signal in response to the sensor/event data and, more specifically, in response to the determination of a missile within attack envelope 200. Exciter control architecture 604 also includes a communication element 616 that comprises a transmitter (and possibly a receiver) for communicating with exciters 104. Communication element 616 transmits the engagement signal to control the activation of exciters 104 in response to the determination of a missile attack.

Exciter control architecture may also include a tracking control element 618 configured to control tracking of exciters 104 relative to the aircraft under observation. In practice, tracking control element 618 can control exciters 104 such that they track aircraft on approach and/or departure, or such that they track aircraft within attack envelope 200. As depicted in FIG. 6, tracking control element 618 may generate tracking control signals that are transmitted to exciters 104 via communication element 616.

Dispenser control architecture 606 includes an engagement signal generator 620 that generates a dispenser engagement signal for controlling the aircraft-mounted dispenser. In the example embodiment, signal generator 620 generates the dispenser engagement signal in response to the sensor/event data and, more specifically, in response to the determination of a missile within attack envelope 200. In the preferred embodiment, dispenser control architecture 606 includes an encoder 622 that transforms the dispenser engagement signal into a coded form prior to transmission. Dispenser control architecture includes a communication element 624 that comprises a transmitter (and possibly a receiver) for communicating with the aircraft-mounted dispensers. In the practical embodiment, the coded engagement signal is broadcast to all aircraft within attack envelope 200 so that the CMs can be deployed regardless of whether any given aircraft is a specific target. Communication element 624 transmits the coded dispenser engagement signal, which controls the dispensing of the CM substance from one or more aircraft within the attack envelope 200.

Upon the detection of a small, very high Doppler target (potentially fused with IR/visual imagery to confirm a missile plume), a coded alert engagement signal is broadcast to airliners in the corridor. This signal (labeled 116 in FIG. 1) is detected by the receiver located in the airliner dispenser subsystem, causing it to begin dispensing a stream of nanocrystals in the slipstream of the airliner. No pilot intervention is required for the deployment of the CM substance. In addition, the ground-based high-power lasers are activated to irradiate the region behind the airliner(s) that are under attack, causing the nanocrystal stream to fluoresce brightly in the IR region corresponding to the peak of jet exhaust emissions. Given the very limited FOV of SF-SAM seekers and limited maneuverability of SF-SAMs, once they are decoyed off the target by the CM hot spot, there is virtually zero likelihood of reacquisition and re-homing.

The laser radiation pattern can create either continuous, modulated or pulsed-intermittent target spots, as well as contra-motion scanned tracks in the slipstream to decoy the missile off target. Or it can create a diffuse, luminous cloud behind the airliner that would degrade the angular information needed by the seeker to steer the missile toward point source targets represented by the jet exhaust.

What if multiple SF-SAMs are launched against the same aircraft, or multiple aircraft in a short time interval? This eventuality is handled by carrying enough nanocrystals in each aircraft, and by dispensing a trail each time a new missile is detected. Since there can be multiple lasers on the ground, the illumination tasking of each laser is handled by relatively simple battle management rules in the engagement control center 102.

The cost of a false alarm in this system is insignificant. The nanocrystal reservoirs in the aircraft dispensers would simply need to be replenished. Aerosols of dispersed nanocrystals (which are virtually inert chemically and smaller than the finest dust) would be carried away by the wind, eventually becoming widely distributed over a very large area, and having insignificant environmental impact.

This system presents a far more realistic decoy than flares and greater maneuverability than towed decoys, since the laser scan on the nanocrystal cloud can keep track with the airliner, and gradually divert the hot spot track from the airliner's track. In contrast, once dispensed, flares become relatively stationary emitters, and more sophisticated missile guidance logic can recognize and ignore such flares.

As described above, CM system 100 employs a CM substance that emits radiation in a certain wavelength band when excited by incident radiation. More particularly, the CM substance emits radiation in a first wavelength band when excited by incident radiation in a second wavelength band. For use as a CM against MANPADS, the CM substance emits infrared radiation with excited by the incident radiation; this infrared radiation approximates the emissions produced by engine exhaust of aircraft. Although any suitable fluorescent or irradiating substance can be utilized in connection with CM system 100, the substance preferably comprises nanocrystals (also known as “quantum dots”). Nanocrystals emit radiation in an emission wavelength band when excited by incident radiation having a wavelength shorter than the emission wavelength.

Nanocrystals are nanometer sized semiconductor crystals that are roughly spherical in shape and have diameters typically ranging from 2-7 nm. Nanocrystals can now be produced relatively inexpensively in mass quantities with precisely controllable optical properties. One of the unique properties of these nanomaterials is that they emit narrowband fluorescence when excited by incident radiation of any wavelength shorter than their emission wavelength. For example, nanocrystals of different diameters in certain materials emit radiation at different visible band wavelengths when illuminated by a common LED source; the color of luminescence may be purple, green, yellow, orange, red, etc.

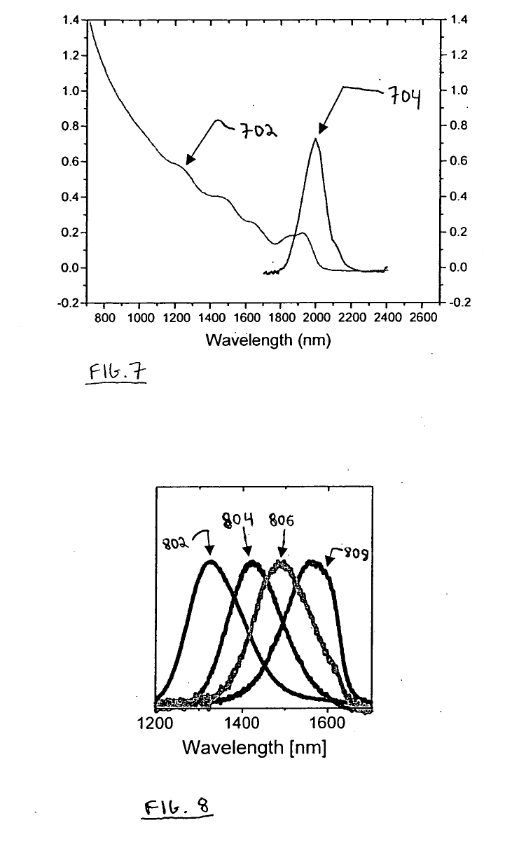

Nanocrystals can be produced with quantum yields for photoluminescence as high as 80%. An illustration of the unique optical characteristics of nanocrystals is shown in FIG. 7, which displays the absorption and emission spectra of a sample of near-IR emitting nanocrystals with an emission peak near 2 microns. The vertical axis on this plot is normalized to an intensity of unity at the first absorption feature (i.e., the peak of the emission spectrum). Plot 702 represents the broadband absorption characteristic and plot 704 represents the narrowband emission characteristic of the sample. While the emission spectrum is narrow and symmetric, the absorption spectrum is extremely broad, extending from only a few nanometers to the blue of the emission wavelength all the way into the deep-UV (not shown below 0.8 microns). This combination of narrow emission with broad absorption is unique to nanocrystals.

The exact wavelength of the emission from a sample of nanocrystals can be precisely engineered as a function of the nanocrystal size, as shown in FIG. 8. In FIG. 8, plot 802 represents the emission spectra of a sample of 3 nm diameter nanocrystals, plot 804 represents the emission spectra of a sample of 4 nm diameter nanocrystals, plot 806 represents the emission spectra of a sample of 5 nm diameter nanocrystals, and plot 808 represents the emission spectra of a sample of 6 nm diameter nanocrystals. Size-dependent optical properties represent another truly unique characteristic of these nanometer-sized materials. The absorption spectra for each of these different emission wavelengths all strongly overlap at wavelengths to the blue of the shortest wavelength emission, as depicted in FIG. 9 for the same nanocrystal material having three different diameters. Since all nanocrystals absorb all light of shorter wavelength than their emission, excitation of multiple wavelengths can be easily accomplished.

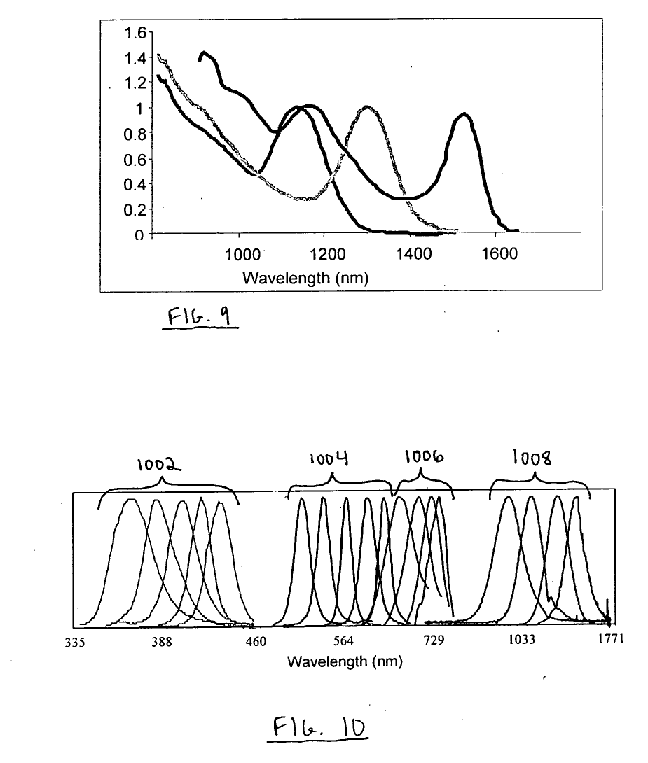

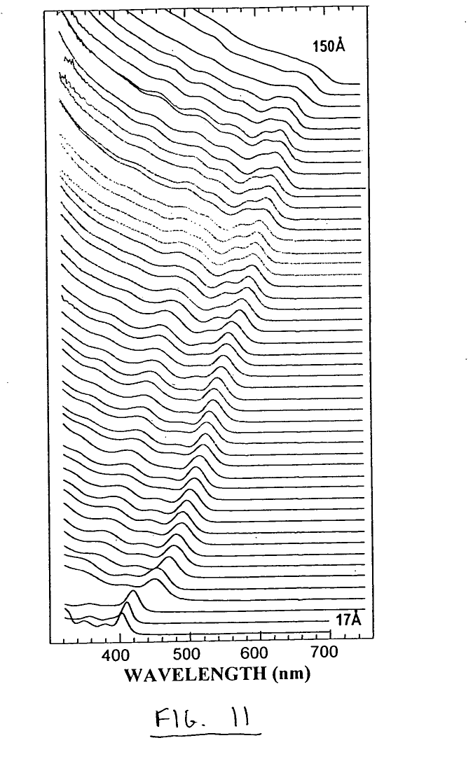

By selecting different semiconductor compositions, it is possible to create nanocrystals with emission wavelengths spanning from the UV into the IR (see FIG. 10). As a design rule, compared to a bulk semiconductor, a nanocrystal formed from the same material will have a bandgap that is shifted to shorter wavelengths relative to the bulk bandgap of the semiconductor. FIG. 10 shows examples of different semiconductor materials with bandgaps tuned as a function of size. The largest nanocrystals of any material will have a bandgap close to that typically associated with material in its bulk form; smaller sizes will have bandgaps of shorter wavelength than that found in the bulk form. As such, it is possible to engineer materials that emit at any desired wavelength. In FIG. 10, the group of plots 1002 represents the emission spectra for different sized nanocrystals formed from a ZnSe material, the group of plots 1004 represents the emission spectra for different sized nanocrystals formed from a CdSe material, the group of plots 1006 represents the emission spectra for different sized nanocrystals formed from an InP material, and the group of plots 1008 represents the emission spectra for different sized nanocrystals formed from an InAs material.

In CM system 100, it is desired to produce emissions in the same spectral window as that typically targeted by MANPADS seekers (2.5 to 4.5 microns with a peak at approximately 4.2 microns). Candidate materials for this spectral range include HgSe, HgTe and InSb. HgTe represents a suitable material for this application, as it can be tuned across the entire seeker range, it produces intense emission at about 4.2 microns, and it can be efficiently excited by a deuterium fluoride laser.

Nanocrystals with multiple different emission wavelengths (i.e., diameters) can even be employed to spectrally match the fluorescence of the mixture to the detection characteristics of a MANPADS seeker. The nanocrystals may be free-standing, but more likely will be embedded in a carrier matrix that is then ground to a fine powder, or embedded in micron sized beads, whichever is cheaper and/or more appropriate. The size of the composite particles can be tailored to match the dispersion requirements.

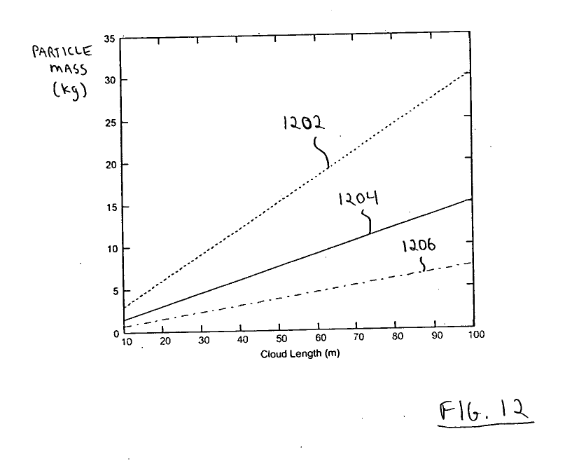

In addition to tunable emission wavelengths, nanocrystals have several other unique properties of interest, including:
1) Narrow emission spectrum. Emission from nanocrystals can be as narrow as 15-20 nm FWHM (full-width half-maximum), allowing many different distinct colors to be emitted simultaneously.
2) Broad excitation spectrum. Unlike organic dyes, nanocrystals can be excited at wavelengths below their emission wavelength, as illustrated in FIG. 11. As such, a plurality of nanocrystal colors can be simultaneously excited with a single wavelength. The excitation can be provided by a ground-based IR laser. FIG. 11 is a graph of absorption spectra of a series of different sized CdSe nanocrystals, ranging from 17 to 150 Angstroms in diameter. Emission from each sample is a few nanometers to the red of the band edge peak. Similar tenability can be achieved in the near-IR band with other nanocrystal materials.
3) High photochemical stability. Nanocrystals are semiconductor crystals, and therefore do not have the degradation mechanisms of organic dyes. As a result, these materials are extremely stable over time and under irradiation, allowing for long-term persistence.
4) Common surface chemistry. Unlike organic dyes, nanocrystal colors can be fabricated with a common surface chemistry, facilitating simple incorporation of different colors into a single carrier material.

By dispersing an aerosol of nanocrystals into the slipstream of an airliner and irradiating the aerosol region behind the aircraft with a high-powered, ground-based laser, either in static pointing or spot scanning mode (simulating fixed or moving point sources) or all along a trail behind the airliner (creating a spatially diffuse high background level), a fluorescent IR background can be synthesized that will confuse the missile seeker, drawing the missile off course. The laser beam is defocused enough to produce a cross-section comparable to a jet engine exhaust, which also provides a margin of safety against a destructively high intensity beam such as would be characteristic of a directed energy weapon.

The ground laser wavelength simply needs to be shorter than the emission wavelength over the desired fluorescence band, with adequate radiated power such that the fluorescent emissions from the crystals will decoy the missile seeker. An analysis of the laser requirements is provided below.

The following description presents a first-order analysis of the quantity of nanocrystals required to produce an adequate aerosol cloud in the slipstream of the airliner. The following assumptions are made to conduct this analysis, all of them supportable by known properties of the nanocrystal material:
1. The nanocrystal material has a density of 5800 kg/m³. This corresponds to CdSe, but is not significantly different for other materials that might be employed.
2. Nanocrystals are 10 nm in diameter.
3. Nanocrystal absorption cross section (σ) is 10⁻¹⁹ m².
4. Quantum efficiency (“QE”) of nanocrystals is 50% (implying that 50% of the optical excitation energy absorbed is reradiated as fluorescent energy).

For simplicity of analysis, we assume the nanocrystals stream behind the aircraft in a square cross section cloud, and that the particle density within this cloud is uniform. This shape assumption is not critical to the results; indeed, a cloud with a circular cross section of a given diameter requires a smaller quantity of nanocrystals to achieve the same effect than one with a square cross section.

We characterize the absorption and emission properties of a nanocrystal cloud by its optical depth, which is defined as the linear distance over which l/e=˜37% of the incident energy is absorbed from the incident laser beam. A high density of particles within a cloud produces a shallow optical depth (i.e., as short as tens of centimeters), while a low particle density could result in an optical depth of tens to hundreds of meters. Also, the higher the density of the particles, the more concentrated the emission hot spot. We define an “optically dense” cloud as one whose optical depth is equal to its cross sectional dimension (i.e., 5 meters in our analysis).

With this characterization, it is straightforward to compute the mass of nanocrystals required to produce an optically dense cloud per unit length of the cloud and the cloud cross sectional dimension. The result of this calculation is shown in FIG. 12, for cloud cross sectional sizes of 2.5, 5, and 10 meters (assuming a cylindrical cloud, these dimensions represent the diameter). In FIG. 12, plot 1202 corresponds to the 10 m size, plot 1204 corresponds to the 5 m size, and plot 1206 corresponds to the 2.5 m size. Thus, about 15 kg (˜33 pounds) of nanocrystals per 100 m are required to produce an optically dense trailing cloud (˜50% longer than the largest commercial airliner) with a 5 m cross section, and twice this amount produces an optically dense cloud of 10 m cross section. (Note that the required density of particles is inversely proportional to the optical depth of the cloud, which results in the linear growth of nanocrystal mass with optical depth for a given length of cloud.) Thus, the airliner should carry enough nanocrystal material to support the few seconds of engagement time needed to decoy the missile. For example, a 10 second engagement (longer than anticipated) for an aircraft moving at 250 km/hr would require a trail length of about 700 m, or about 100 kg of material.

Greater efficiencies in the use of the nanocrystals can be achieved by a dispersal mechanism that produces a flat, rectangular cross section cloud (i.e., one that is horizontally wide, but with a vertically thin optical depth). Such a cloud will have a higher density of nanocrystals to produce the short optical depth, but a smaller volume, and could be created using a flat, horizontally oriented dispersal nozzle.

The following description addresses the laser power requirements to achieve a hot spot of comparable or greater intensity than a typical jet engine exhaust. For the latter, we consider a black body radiating surface at a temperature of 1000 K. For the 2.5 to 3 micron band, the radiated power density of a surface at this temperature is 2020 watts/steradian-m² along the bore sight perpendicular to the surface.

Since the distance from the jet engine to the SAM is approximately the same as the distance from the cloud to the SAM during the critical phase of the engagement (since the missile must approach from the rear hemisphere, the jet engine is actually at greater distance), we can compare photon fluences at the SAM seeker from the nanocrystal cloud emission and the jet engine exhaust at the same range, and require that the former be brighter than the latter. We ignore atmospheric attenuation and out scatter as being comparable for the two sources.

At a 2 km range from the SAM to the aircraft, the SAM seeker (with an assumed aperture of 2 cm) observes a power level from a jet engine exhaust of

$$2020 watts \text{/} sr \text{-} {m}^{2} * \frac{{π ( .01 )}^{2}}{{2000}^{2}} sr * 1 {m}^{2} \approx 1.6 * {10}^{- 7} watts$$

of received power. Thus we need the same or greater power signal from the nanocrystal cloud emissions in order successfully to decoy the SAM.

Now the cloud hot spot radiates into 4π steradians, to first order. Thus the laser power level PL must be such that

$$\frac{PL * QE * ( 1 / e )}{4 π} \text{watts/} sr * \frac{{π ( .01 )}^{2}}{{2000}^{2}} sr \geq 1.6 * {10}^{7} watts$$

where QE, the quantum efficiency, is assumed to be 50%. Solving for PL, we find that the laser output power must satisfy
PL≧˜140 kwatts
in order to produce a brighter hot spot than the jet engine exhaust. This is well within the power range of high-energy laser technology to produce, especially considering the brief engagement times that are required.

If the exhaust temperature is taken to be 700 degrees K, then the required PL is about 14.5 kwatts. This output power is commensurate with the power of currently available solid state lasers, while the higher output power (140 kwatts) is far below the power of currently available deuterium fluoride chemical lasers. Both of these laser technologies are candidates for tactical laser weapons systems and, thus, are able to fire rapidly. In addition, at these power ranges, such lasers can be trailer or vehicle mounted.

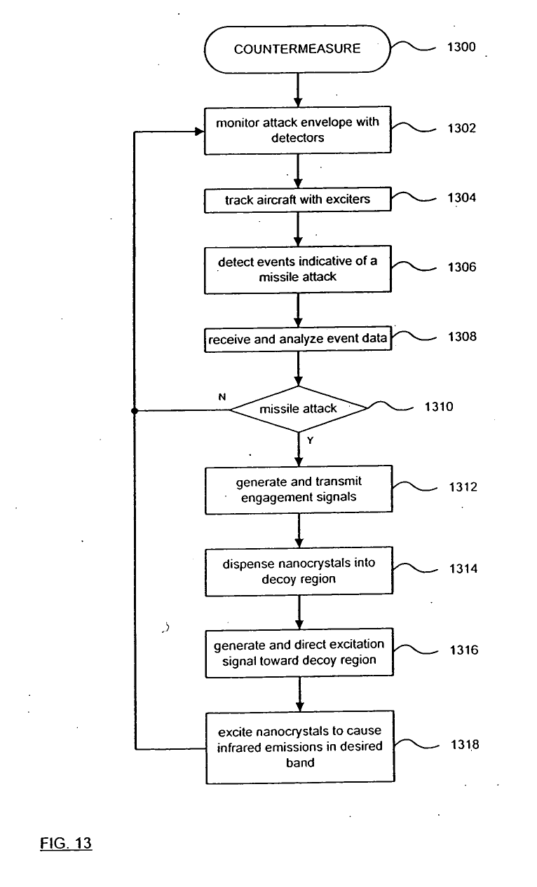

FIG. 13 is a flow chart of an example CM process 1300 that may be carried out by a CM system configured in accordance with the invention. In a practical deployment, process 1300 may include any number of additional and/or alternative tasks, and process 1300 may be incorporated into a larger, more sophisticated CM procedure. Furthermore, the tasks in process 1300 need not be performed in the order shown in FIG. 13, and one or more of the tasks may be performed simultaneously.

CM process 1300 includes a task 1302, during which the aircraft attack envelope is monitored for the presence of missiles. In the example embodiment described herein, task 1302 is performed by one or more detectors such as the Doppler-sensitive radars. The detectors are preferably controlled to scan the airspace within the approach/departure corridors proximate the airport. In addition, a task 1304 is performed, during which the aircraft (or an area proximate the aircraft) is tracked by one or more of the exciters. The exciters preferably track aircraft within the attack envelope and, in particular, on approach and departure. If no threat is present, then the exciters track the aircraft in an inactive state. Such tracking may be controlled by the engagement control subsystem and/or by the exciter subassemblies.

Detection of events indicative of a missile attack within the attack envelope occurs during a task 1306. In the example embodiment, one or more of the radar detectors perform task 1306. The event or sensor data is communicated to the engagement control subassembly, where it can be analyzed and processed to determine whether a missile is actually present within the attack envelope (task 1308). As mentioned above, data fusion, artificial intelligence, neural network, and other processing techniques can be employed to make this determination. If the system decides that a missile attack has been launched (query task 1310), then a task 1312 can be performed. If the system decides that no missiles are present in the protected envelope, then CM process 1300 is re-entered at task 1302 for continued monitoring of the airspace.

In response to the determination of a missile attack, one or more engagement signals are generated (task 1312). In this example, the engagement control subsystem generates a coded dispenser engagement signal and an exciter engagement signal for transmission to the respective components of the CM system. The coded dispenser engagement signal is configured to control the dispensing of the CM substance from aircraft within the attack envelope. In this regard, the engagement control subsystem can transmit the dispenser engagement signal in a broadcast manner for possible reception by all aircraft located within the attack envelope. Thus, if multiple aircraft receive the dispenser engagement signal, then each will react accordingly by dispensing the CM substance (e.g., the nanocrystals) into the decoy region behind the respective aircraft (task 1314).

During task 1312, the engagement control subsystem transmits the exciter engagement signal to the exciters. Upon receipt of this engagement signal, an exciter generates a suitably configured excitation signal and directs the excitation signal toward the decoy region that contains the dispensed substance (task 1316). In this manner, CM process 1300 illuminates the region containing the nanocrystals with radiation having properties that cause the nanocrystals to emit radiation having IR characteristics that approximate the IR characteristics of the engine exhaust of the targeted aircraft (task 1318). As described above, the nanocrystal size and composition and the excitation signal characteristics (e.g., wavelength and power) are selected such that, when excited, the nanocrystals emit IR radiation in a desired band. The exciter may also be controlled to track the aircraft with the excitation signal as necessary to illuminate additional nanocrystals deployed from the aircraft.

In a practical deployment, CM process 1300 provides continuous monitoring and protection within the attack envelope. Accordingly, after task 1318, process 1300 is re-entered at task 1302 to continue the monitoring task.

In summary, the system described herein has numerous desirable features and benefits relative to conventional military CM systems and tactics. Among these are the following:
1. Expense. This system minimizes the back fit required to airliners, eliminating expensive IR warning receivers and dangerous flammable stores. All of the more sophisticated and expensive system components are ground-based, scaling only as the number of airports, not as the number of airliners.
2. Incremental installation. This system can be installed incrementally with a little attention given to aircraft route scheduling. Aircraft using the airports considered to be at highest risk can be back fitted first with the nanocrystal dispenser subsystems, and the ground equipment can be installed first at these airports.
3. Safety. The system presents no danger of flammable or hard metal objects falling into populous or wooded areas as a result of a false alarm. The only physical emissions of the system are the nanocrystal aerosol cloud, which is harmless and environmentally benign. Furthermore, by slightly defocusing the laser beam, we can produce fluorescent spots of a size that will decoy the missile without being of a dangerously high intensity should they impinge on the aircraft.
4. Reliability. Missiles in flight within the corridor will have uniquely high Doppler signatures, and thus the false alarm rate of the system will be exceptionally low. This may not be true at all of an aircraft mounted IR warning receiver looking down at an urbanized area, where any open flame or heat source of sufficient intensity could generate a false alarm. In addition, the system described herein is comprised of components that can achieve very high reliabilities, with long mean time between failure.
5. Autonomous operation. This system can be completely automated safely, so that no manual response by the pilots is required during the most critical phases of flight (landing and takeoff). Pilots can of course be notified of the activation of the nanocrystal dispenser; however, they would not have to become involved in the engagement, as would be the case if evasive maneuvers were required. Since engagements of this type are typically very short in duration, this is a desirable feature.
6. Quick response. This system can be prototyped, built and deployed rapidly as compared with other alternatives. The longest lead-time items would likely be the ground-based lasers. However, existing high-powered laser systems (commercial and/or weapons program variants) should be available.
7. Psychology. Not to be overlooked is the psychological deterrence of a technically sophisticated solution such as this. Inexperience with this type of CM could well deter attackers from risking an attack with an unknown likelihood of failure, for fear of paying the cost of reprisals without having achieved their goal.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

1. A countermeasure (“CM”) system for the defense of aircraft against missile attack, said system comprising:
a dispenser mounted on an aircraft and configured to dispense a substance into an area within an attack envelope of said aircraft, said substance emitting radiation in a first wavelength band when excited by incident radiation in a second wavelength band; and
at least one exciter configured to generate illuminating radiation in said second wavelength band, and to direct said illuminating radiation toward said area.

2. A CM system according to claim 1, wherein:
said at least one exciter is configured to generate said illuminating radiation in response to the determination of a missile attack within said attack envelope of said aircraft; and
said dispenser is configured to dispense said substance in response to the determination of said missile attack.

3. A CM system according to claim 1, wherein said substance comprises nanocrystals.

4. A CM system according to claim 1, wherein said substance emits infrared radiation when excited by said incident radiation.

5. A GM system according to claim 1, wherein the wavelength of said incident radiation is shorter than the wavelength of radiation emitted by said substance.

6. A CM system according to claim 1, wherein the wavelength of radiation emitted by said substance approximates the wavelength of emissions produced by engine exhaust of said aircraft.

7. A CM system according to claim 1, wherein said at least one exciter is ground-based.

8. A CM system according to claim 1, wherein said at least one exciter comprises at least one laser emitter.

9. A CM system according to claim 8, wherein said at least one laser emitter tracks said aircraft within said attack envelope of said aircraft.

10. A CM system according to claim 8, wherein said at least one laser emitter tracks said aircraft on approach/departure.

11. A CM system according to claim 1, further comprising at least one detector configured to detect events indicative of the presence of a missile within said attack envelope of said aircraft.

12. A CM system according to claim 11, wherein said at least one detector comprises at least one Doppler-sensitive radar.

13. A CM system according to claim 11, wherein said at least one detector comprises at least one visual imaging element.

14. A CM system according to claim 11, wherein said at least one detector comprises at least one infrared imaging element.

15. A CM system according to claim 11, further comprising an engagement control subsystem in communication with said at least one detector, with said at least one exciter, and with said dispenser, said engagement control subsystem being configured to analyze data corresponding to said events to determine whether a missile is present within said attack envelope, to control said at least one exciter, and to control said dispenser.

16. A CM system according to claim 15, wherein said engagement control subsystem is configured to activate said at least one exciter in response to the determination of said missile attack.

17. A CM system according to claim 15, wherein said engagement control subsystem is configured to control tracking of said at least one exciter relative to said aircraft.

18. A CM system according to claim 15, wherein:
said engagement control subsystem comprises a transmitter configured to transmit an engagement signal in response to the determination of said missile attack; and
said dispenser is configured to dispense said substance upon receipt of said engagement signal.

19. A CM system according to claim 18, further comprising an engagement signal receiver mounted on said aircraft, said engagement signal receiver being configured to receive said engagement signal.

20. A CM system according to claim 19, wherein said dispenser includes said engagement signal receiver.

21. A countermeasure (“CM”) method for the defense of aircraft against missile attack, said method comprising;
dispensing an aerosol of a substance into a region proximate an aircraft in response to the determination of a missile attack within an attack envelope of said aircraft, said substance emitting radiation in a first wavelength band when excited by incident radiation in a second wavelength band; and
illuminating said region with radiation in said second wavelength band.

22. A CM method according to claim 21, wherein said illuminating step is performed in response to the determination of said missile attack within said attack envelope of said aircraft.

23. A CM method according to claim 21, further comprising:
detecting events indicative of the presence of a missile within said attack envelope of said aircraft; and
determining, in response to said detecting step, the presence of a missile within said attack envelope of said aircraft.

24. A CM method according to claim 21, further comprising transmitting an engagement signal in response to the determination of said missile attack within said attack envelope of said aircraft, wherein said dispensing step is performed in response to the transmission of said engagement signal.

25. A countermeasure (“CM”) subsystem for the defense of aircraft against missile attack, said subsystem comprising:
a controller configured to receive an engagement signal indicative of the presence of a missile within an attack envelope of an aircraft; and
an exciter connected to said controller, said exciter being configured to generate, in response to said engagement signal, an excitation signal and to direct said excitation signal at an area, proximate said aircraft, that contains a substance dispensed in response to the presence of said missile within said attack envelope of said aircraft; wherein
said excitation signal has properties that cause said substance to emit radiation having characteristics that approximate characteristics of engine exhaust of said aircraft.

26. A CM subsystem according to claim 25, wherein:
said substance emits radiation in a first wavelength band when excited by incident radiation in a second wavelength band; and
said excitation signal comprises radiation in said second wavelength band.

27. A CM subsystem according to claim 26, wherein the wavelength of said excitation signal is shorter than the wavelength of radiation emitted by said substance.

28. A CM subsystem according to claim 25, wherein said exciter is ground-based.

29. A CM subsystem according to claim 25, wherein said exciter comprises at least one laser emitter.

30. A CM subsystem according to claim 29, wherein said controller causes said at least one laser emitter to track said aircraft within said attack envelope of said aircraft.

31. A CM subsystem according to claim 29, wherein said controller causes said at least one laser emitter to track said aircraft on approach/departure.

32. A countermeasure (“CM”) method for the defense of aircraft against missile attack, said method comprising:
receiving an engagement signal indicative of the presence of a missile within an attack envelope of an aircraft;
generating, in response to said engagement signal, an excitation signal; and
directing said excitation signal at an area, proximate said aircraft, that contains a substance dispensed in response to the presence of said missile within said attack envelope of said aircraft; wherein
said excitation signal has properties that cause said substance to emit radiation having characteristics that approximate characteristics of engine exhaust of said aircraft.

33. A CM method according to claim 32, further comprising tracking said aircraft with said excitation signal.

34. A countermeasure (“CM”) subsystem for the defense of aircraft against missile attack, said subsystem comprising:
a receiver configured to receive an engagement signal indicative of the presence of a missile within an attack envelope of an aircraft; and
a dispenser mounted on said aircraft and configured to dispense a substance in response to said engagement signal, said substance emitting radiation in a first wavelength band when excited by incident radiation in a second wavelength band.

35. A CM subsystem according to claim 34, wherein said substance comprises nanocrystals.

36. A CM subsystem according to claim 34, wherein said substance emits infrared radiation when excited by said incident radiation.

37. A CM subsystem according to claim 34, wherein the wavelength of said incident radiation is shorter than the wavelength of radiation emitted by said substance.

38. A CM subsystem according to claim 34, wherein the wavelength of radiation emitted by said substance approximates the wavelength of emissions produced by engine exhaust of said aircraft.

39. A CM subsystem according to claim 34, wherein said receiver is integrated with said dispenser.

40. A countermeasure (“CM”) method for the defense of aircraft against missile attack, said method comprising:
receiving, at an aircraft, an engagement signal indicative of the presence of a missile within an attack envelope of said aircraft; and
dispensing a substance from said aircraft in response to said engagement signal, said substance emitting radiation in a first wavelength band when excited by incident radiation in a second wavelength band.

41. A CM method according to claim 40, wherein said receiving step receives said engagement signal in a coded form.

42. An engagement control subsystem for the defense of aircraft against missile attack, said engagement control subsystem comprising:
a receiver configured to receive sensor data indicative of the presence of a missile within an attack envelope of an aircraft; and
a first control architecture configured to generate, in response to said sensor data, a first engagement signal for controlling at least one exciter, said at least one exciter being configured to generate an excitation signal and to direct said excitation signal at an area that contains a substance dispensed from said aircraft; wherein
said excitation signal has properties that cause said substance to emit radiation having characteristics that approximate characteristics of engine exhaust of said aircraft.

43. An engagement control subsystem according to claim 42, further comprising a second control architecture configured to generate, in response to said sensor data, a second engagement signal for controlling the dispensing of said substance from said aircraft.

44. An engagement control subsystem according to claim 43, wherein said second control architecture is further configured to generate said second engagement signal in a coded form.

45. An engagement control subsystem according to claim 42, wherein said substance emits radiation in a first wavelength band when excited by incident radiation in a second wavelength band; and
said excitation signal comprises radiation in said second wavelength band.

46. An engagement control subsystem according to claim 42, further comprising a processor configured to analyze said sensor data to determine whether a missile is present within said attack envelope.

47. An engagement control subsystem according to claim 42, wherein said first control architecture is further configured to cause said at least one exciter to track said aircraft within said attack envelope of said aircraft.

48. An engagement control subsystem according to claim 42, wherein said first control architecture is further configured to cause said at least one exciter to track said aircraft on approach/departure.

49. A countermeasure (“CM”) method for the defense of aircraft against missile attack, said method comprising:
receiving sensor data Indicative of the presence of a missile within an attack envelope of an aircraft; and
generating, in response to said sensor data, a first engagement signal for controlling at least one exciter, said at least one exciter being configured to generate an excitation signal and to direct said excitation signal at an area that contains a substance dispensed from said aircraft; wherein
said excitation signal has properties that cause said substance to emit radiation having characteristics that approximate characteristics of engine exhaust of said aircraft.

50. A CM method according to claim 49, further comprising generating, in response to said sensor data, a second engagement signal for controlling the dispensing of said substance from said aircraft.

51. A CM method according to claim 50, wherein said second engagement signal comprises a coded signal.

52. A CM method according to claim 49, further comprising processing said sensor data to determine whether a missile is present within said attack envelope.

53. A CM method according to claim 49, further comprising controlling said at least one exciter to track said aircraft within said attack envelope of said aircraft.

54. A CM method according to claim 49, further comprising controlling said at least one exciter to track said aircraft on approach/departure.
